(19) United States
(12) Patent Application Publication
(10) Pub. No.: US 2009/0307093 A1
(43) Pub. Date: Dec. 10, 2009

(54) METHOD FOR SELECTING AN ADVERTISING MESSAGE WITHIN A PLATFORM

(75) Inventors: Yves BERTONI, Velizy (FR); Armen AGHASARYAN, Nozay (FR); Yann TOMS, Nozay (FR); Stephane BETGE BREZETZ, Nozay (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/480,866

(22) Filed: Jun. 9, 2009

(30) Foreign Application Priority Data
Jun. 9, 2008 (FR) 0853820

(51) Int. Cl. G06Q 30/00

(52) U.S. Cl. 705/14.66

(57) ABSTRACT

In the method for selecting an advertising message to be sent to a user's (18) device (40), at least one commercial device (4) selects a piece of content from among multiple pieces of advertising content based on the criteria of the commercial device (4) and/or criteria which is specific to the user and distinct from the commercial device's criteria, then sends the selected content to a decision apparatus (8) capable of selecting content from among the content received from the commercial device and from other commercial devices.

This application is based on and claims the benefit of French Patent Application 0853820 filed on Jun. 9, 2008, which is incorporated by reference herein in its entirety.

### 1. TECHNICAL FIELD

The invention relates to automated advertising platforms.

### 2. BACKGROUND

Advertising platforms are known, which make it possible to adopt strategies formulated to target various audiences, and benefit from databases of individual profiles. For now, their application is limited to tracking Internet users. However, they will quickly expand to all advertising channels available over personal electronic digital devices. Such channels include Internet television (IPTV), mobile telephony portals, mobile video, MMS and SMS messaging systems, etc. This outlook for greater interactivity, as well as the appearance of new indicators and new measures of performance, will make it possible to more effectively track campaigns and individual contacts.

These technological developments will likely have a deep impact on marketing practices. Sellers and advertisers will therefore be faced with new challenges, such as confronting an increasing variety of audiences to target, while simultaneously pursuing different goals. Their challenges also involve quickly optimizing their range of advertising, in order to account for enhances measures of performance and changing goals. Such problems cannot be resolved with static planning or manual advertising campaign tracking.

There is therefore a present need for a platform which makes it possible to automatically manage a potentially large and varied number of audiences identified by a given advertiser. Under such circumstances, it is desirable to be able to automatically optimize the range of advertising, accounting for the various goals being pursued, advertising performance, or measurements of impact.

Furthermore, the system must take into account, preferably in as balanced a way as possible, the explicit goals and interests of the consumers, sellers, and advertisers, and those of the platform's operators.

By “advertisers” we are here referring to people who work on commercial strategies within advertising/marketing companies. Additionally, we use the term “sellers” to denote the people in charge of such commercial strategies within companies in order to sell those companies' products and services.

The Google Ad-Words platform is known. It does not enable sellers and advertisers to set qualitatively or quantitatively rich marketing goals, nor to subdivide them in terms of performance outcomes, whether within the audience or campaign level, or within the level of the advertising itself. The target audience is identified by a set of searched-for keywords, and only the maximum budget is taken into account. The Google Ad-Words process is designed to maximize Google's earnings. It can be used to place advertisements at the right time once interest has been shown. Additionally, the expenses paid by the advertiser are only costed once the Internet user concretely becomes a prospect by clicking on the advertising link.

Other solutions, such as the Yahoo platform, or the method known as DoubleClick, make it possible to track Internet users' behavior and to sort them into categories for the purpose of selecting the most appropriately targeted advertising.

### SUMMARY

One goal of the invention is to give advertising platforms better performance.

To that end, the invention discloses a method for selecting an advertising message to be sent to a user's apparatus, wherein at least one commercial device selects a piece of content from among multiple pieces of advertising content based on the commercial device' criteria and/or criteria specific to the user and distinct from the commercial device's criteria, then sends the selected content to a decision apparatus capable of selecting a piece of content from among the content received from the commercial device and from other commercial devices.

In this manner, smart agents act on behalf of the advertisers based on their interests, and automatically adjust their offerings to match performance and goals. The invention also makes it possible to increase the profitability of the advertisers' investments, and to make better use of the capabilities of an advertising platform, in particular the database of consumer profiles. This is done by enabling rich and varied targeting in connection with different measures of performance. The invention makes it possible to derive greater benefits from the targeting of advertising, by making it possible to specify quantitative and qualitative marketing goals, as well as performance indicators. Typical commercial goals will include, for example, building consumer awareness, maintaining relations with the consumer, maximizing return on investments, generating clickthroughs, etc. The seller or advertiser may provide a batch of advertising content that corresponds to a set of target audiences, then leave it up to the system to automatically choose the best advertising content, taking into account measurements of impact or marketing goals.

The method will advantageously include at least one of the following characteristics:
the (or each) commercial device respectively corresponds specifically to one vendor or one predetermined company;
a user's management device sends the user's advertising data to the decision apparatus;
the decision apparatus converts the data to produce user criteria;
the decision apparatus sends the user criteria to the (or each) commercial device;
at least one of the following components of the commercial device sends to a decision-making component of the commercial device at least one of the following commercial device criteria: a target audience management component, a commercial goal management component, an advertising impact checking component, and a budget management component;
the commercial device's criteria comprise at least one of the following criteria: a commercial communication goal criterion, a recorded advertising performance indicator criterion, a budget criterion, a target audience criterion, a predetermined interests criterion, and preferably all of these criteria; and
the decision apparatus selects the content, taking into account criteria distinct from the user criteria and distinct from the criteria of the (or each) commercial device.

The invention also discloses a program which includes instructions capable of controlling the execution of the steps of an inventive method whenever it is run on a computer, a data-recording medium which comprises such a program, and the provision of such a program over a telecommunication network so that it may be downloaded.

The invention also discloses an advertising management platform which comprises:
at least one commercial device for selecting advertising content to be sent to a user's apparatus, the (or each) commercial device comprising means for selecting content from among multiple pieces of advertising content based on the device's criteria and/or criteria specific to the user and distinct from the device's criteria; and
a decision apparatus capable of selecting content from among the content received from the commercial device and from other commercial devices.

The (or each) commercial device preferably comprises a decision-making component, and preferably at least one of the following components independent of the decision-making component: a target audience management component, a commercial goal management component, an advertising impact checking component and a budget management component, each one advantageously in a separate form.

Advantageously, the platform comprises at least one advertising management apparatus specific to a user and distinct from the (or each) commercial device.

### 4. BRIEF DESCRIPTION OF THE DRAWINGS

Other characteristics and advantages of the invention will become more apparent in the following description of a preferred embodiment, given as a non-limiting example with reference to the attached drawings, in which:

FIG. 1 is an overview diagram of an advertising platform according to one embodiment of the invention;

FIG. 2 is a similar diagram, showing one aspect of this platform's configuration; and

FIG. 3 is a flowchart depicting one embodiment of the inventive method.

### 5. DESCRIPTION OF EMBODIMENTS

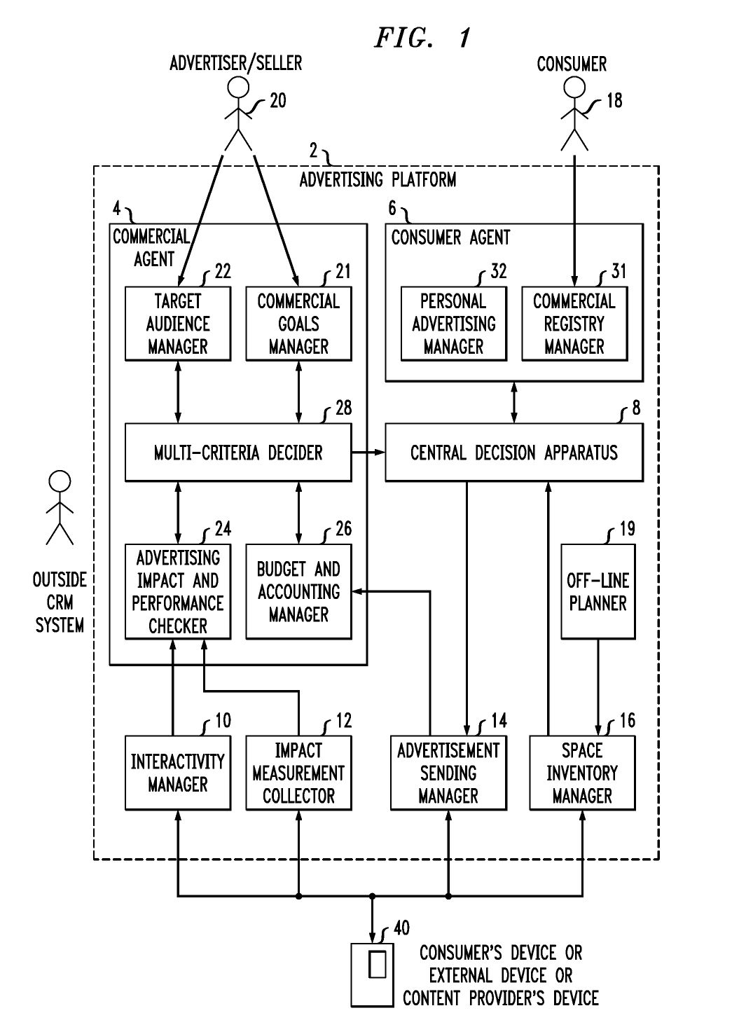

FIG. 1 depicts an advertising platform 2 according to one embodiment of the invention.

This platform is embodied by at least one tangible device, such as a computer, a server, etc., or a set of elements of such a type forming a system. The various components which make up this platform may be implemented individually or as groups of multiple components, in the form of software, by a program or application. These various components may be geographically combined together, or alternatively may be scattered and remote from some of the others. In the latter situation, they shall communicate over a suitable network, such as the Internet.

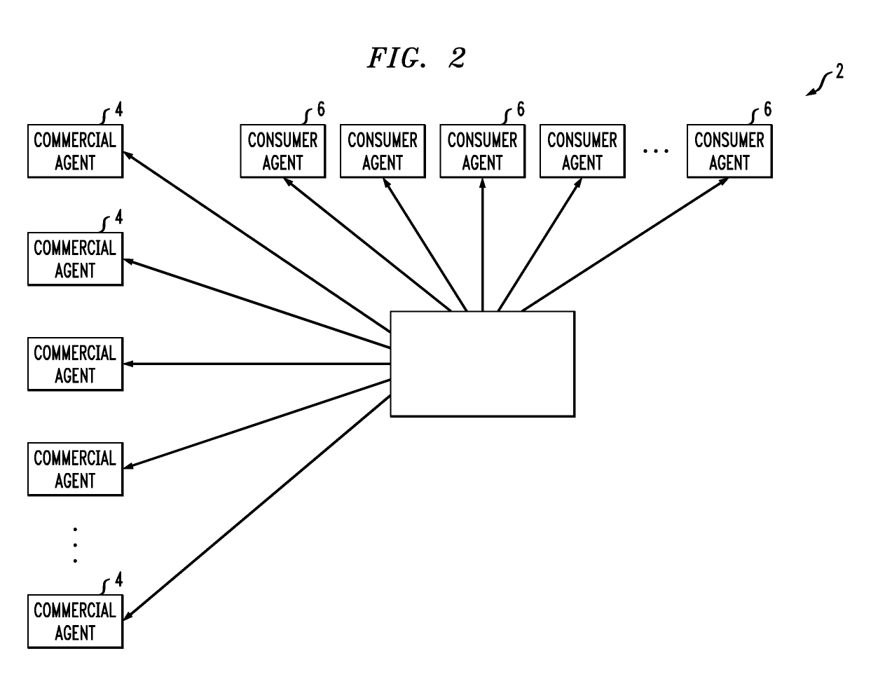

The platform 2 typically comprises multiple commercial agents 4 such as the one depicted in FIG. 1. It also comprises multiple consumer agents, such as the one 6 depicted in the same figure. Although a single commercial agent and a single consumer agent have been illustrated in this figure, this is only for the sake of simplicity in the depiction. To that end, the fact that the platform 2 comprises multiple commercial agents 4 and multiple consumer agents 6 has been more clearly illustrated in FIG. 2.

The platform comprises a central decision apparatus 8 as well as the following separate components:
an interactivity manager 10,
an impact measurement collector 12,
an advertisement sending manager 14,
a space inventory manager 16, and
an offline scheduler 19.

The invention forms an intelligent system based on the cooperation of various agents within the advertising platform 2. This platform may target various forms of media. Its purpose is to select advertising content to send to consumers 18 over said consumers' digital devices 40.

The invention makes it possible to optimize an advertising campaign automatically, taking into account data and criteria from sellers and advertisers 20, consumers 18 (particularly with respect to potential advertising spaces), and the platform's operator. It optimizes advertising campaigns, while taking into account the varied and potentially conflicting goals of these three types of stakeholders as much as possible.

In this application, the term “advertising space” is used to refer to a slot in which an advertising message may be sent to the consumer's device 40. It may, for example, be a message displayed on the device's monitor when the consumer checks the device.

Within the scope of the invention, as shall be seen, the respective goals and interests of advertisers and sellers 20, consumers 18 and the platform's operator are articulated, transmitted and tracked by various software means in the form of agents which work in concert.

The invention enables sellers and advertisers to simultaneously track numerous target audiences, to which different marketing goals are associated. It makes it possible to achieve the automatic tracking of these advertising campaigns over all digital channels. It enables sellers and advertisers to set marketing goals which either apply comprehensively or are specific to an audience or a particular campaign. The invention makes it possible to centralize and aggregate the varied results in terms of impact in order to deduce therefrom common measures of performance, such as clickthrough rates, Internet website visits, telephone calls, etc.

The invention makes it possible to automatically optimize and adapt advertising offerings, taking into account the interests of the consumers 18 and the goals sought by the sellers and advertisers, as well as measurements or estimates of performance or impact.

Two major elements of the platform 2 will now be described: The commercial agent 4, which acts on behalf of the advertiser or seller 20, and the consumer agent 6, which acts on behalf of the consumer 18. These agents negotiate with the central decision apparatus 8 or negotiator, which makes the final choice of which advertising content to send to the consumer, based on the specific policy of the advertising platform's operator. This policy may, for example, deal with sophisticated targeting in terms of compensation, maximizing earnings, etc.

The commercial agent 4 comprises the following modules or components:

It comprises a commercial goal manager 21. This module's task is updating and summarizing the marketing goals of the advertiser or seller 20, whether they are at the level of the brand overall, the target audience, the campaign, or an individual advertising message. The goals may be quantitative and divided into performance results, or they may be purely qualitative. By way of example, quantitative goals may be expressed as a minimum clickthrough rate for the campaign. Typical qualitative goals may, for example, consist of maintaining relations with an audience, building audience awareness of the product or service, developing familiarity with an audience, maximizing contacts with an audience, and so on. It should be made clear at this point that the commercial goals may change dynamically over time, and are not static. The multicriteria decider 28 (which will be described below) may be induced to account for it by means of the logic incorporated therein.

The commercial agent 4 also comprises a target audience manager 22. The purpose of this module is to establish and update the graph of target audiences, as well as their mutual inclusion and/or overlapping relationships. It also organizes connections between a batch of advertising campaigns and these campaigns' target audiences. It provides the advertiser or seller 20 with a full portrait of these campaigns and these audiences.

The task of the commercial agent's advertising impact and performance checker 24 is to perform statistical calculations regarding the impact and performance of the advertising and the campaigns. To do so, it collects various data ranging from interactivity or clickthrough reports to outside event notifications such as telephone calls, subscriptions to websites, etc. These measurements are converted into common impact or performance indicators, whether at the level of the audience, the campaign, or the advertising message itself. By way of example, one typical performance indicator may be the sell-through rate.

The commercial agent 4 further comprises a budget and accounting manager 26 responsible for establishing and managing the budget and accounts. This task is performed both at the overall level and at the level of a single audience or campaign.

Finally, the commercial agent 4 comprises a multi-criteria decider 28. This module's task is to select a piece of content or an advertising offering whenever it receives an invitation to that effect from the platform's central decision apparatus 8. It is capable of making a multi-criteria decision including various criteria. It also knows how to implement multi-goal optimization methods. It acts based on the goals specified by the advertiser or seller 20, the budget, and the measured or estimated individual performance. It is capable of implementing a selection logic which draws on various criteria; for example, priorities among goals, the target audiences' commercial weight, the commercial offerings available, the degree of targeting, etc.

The consumer agent 6 defends the interests, desires, preferences or requirements of the consumer 18. To that end, it maintains a personal marketing registry 31 which includes the history of the consumer's advertising exposure, data on his or her interactivity context, etc.

The consumer agent 6 further comprises a personal advertising manager 32 indicating the consumer's preferences with regard to goals and restrictions. For example, one of the manager's goals 32 may be to make the set of advertising messages which the user encounters as rich and varied as possible, blocking certain advertisements or themes which had just been sent to him or her shortly beforehand, or which he or she does not appreciate. It may also express preferences for favorite brands or particularly appreciated messages. The manager 32 may be configured by either the platform or the consumer 18, and receive adjustments and data from either one. Its influence on the selection of the final message may vary depending on the policy followed by the platform 2. This influence may range from a simple expression of desires or preferences to a decisive influence on the advertisement ultimately chosen.

The interactivity manager module 10 provides interactivity reports to the advertising impact and performance checker 24. The impact measurement collector 12 gathers impact and performance events from outside systems and apparatuses. The manager 10 and the collector 12 transmit their data to the checker 24. The advertisement sending manager 14 transmits data to the manager 26. Finally, the space inventory manager 16 informs the central decision apparatus 8 of events which pertain to the availability of advertising space.

The inventive method may, for example, be implemented as follows. The manner in which the agents 4 and 6 are induced to dialogue and negotiate with the decision apparatus 8 is thereby described below.

It is assumed that a space has become available on a given consumer's 18 device 40, within the context associated therewith. It is further assumed that no offline scheduling, as may have been performed by the platform's offline scheduler 19, has been carried out for this space. A competition may therefore be held between the various advertisers and sellers 20.

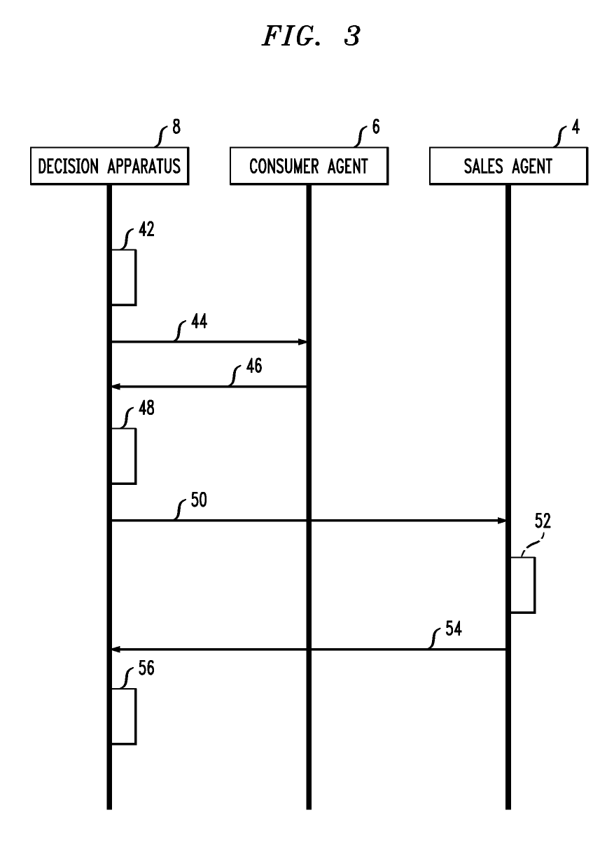

During a step 42 with reference to FIG. 3, the central decision apparatus 8 checks the consumer's 18 profile.

During a following step 44, it requests from the agent 6 restriction or preference data pertaining to the consumer, such as a list of advertisements which have already been recently displayed on his device 40. The data may also comprise a list of prohibited advertisements or themes, a list of unappreciated themes, a list of subjects which are preferred under the present context, etc.

It obtains this data during the next step 46.

Depending on its policy, during a step 48 the decision apparatus 8 may then convert this data into either firm restrictions or preferences. If so, restrictions or preferences form the criteria specific to the consumer 18.

During a following step 50, the decision apparatus issues an invitation to offer a piece of advertising content for this space to the deciders 28 of the commercial agents 4. The consumer's data (regarding his or her restrictions or preferences) are attached to this invitation. This data may, in particular, be taken into consideration when a competition or bidding process occurs between the advertisers or sellers 20, in the absence of scheduling as with this situation.

After receiving this invitation, each agent 4, during a step 52, selects from among several pieces of advertising content the one which it determines is best-suited based on the specific goals of the advertiser or seller, observed performance indicators, budget data and target audiences which include the consumer 18. Thus, the target audience manager 22 is induced to convey to the decider 28 criteria regarding target audiences. The commercial goal manager 21 conveys to the decider 28 commercial communication goal criteria. The advertising impact and performance checker 24 conveys recorded advertising performance indicator criteria to the decider. The budget and accounting manager 26 conveys budget and accounting criteria to the decider 28.

As an example, the following situation may be reached. For a first commercial agent A, the consumer 18 is part of two different audiences. For the first audience, the goal pursued is to maintain a relationship with the consumers, and the offers to adopt are the ones which generate the most clickthroughs. For the second audience, the goal is to develop awareness of a product, and a non-interactive advertisement is desirable. That agent's decider 28 is induced to implement a logical process in order to determine, on the basis thereof, the best advertising offer to display to the consumer. This process may, in particular, involve calculating scores or ratings for each of the potential alternatives. The decider shall therefore select the advertising content which gets the best rating.

Within a second commercial agent B, the consumer 18 belongs to only one target audience, but this audience is targeted by two campaigns associated with different performance goals. For example, that agent's decider 28 may then determine that an advertisement from the second campaign must be favored, because it has been less successful in achieving its goals.

More generally, it is seen that the decider 28 shall be induced to make a decision that takes into account several criteria, i.e. the criteria derived from the consumer agent 6 and conveyed by the decision apparatus 8, and the criteria from the modules 20, 21, 24, and 26.

During a step 54, each commercial agent 4 conveys the selected offer to the decision apparatus 8.

During a next step 56, the decision apparatus, which additionally takes into account the specific interests of the platform's operator, decides which of the received advertising content must ultimately be sent to the consumer. The platform operator's criteria may, for example, pertain to maximizing its profits.

The advertisement sending manager 14 distributes the ultimately selected advertisement to a content provider in order to be sent to the consumer's device 40, or directly to that device.

The invention enables the advertiser or seller 20 to simultaneously enter different marketing goals into the system. These goals may be qualitative or quantitative, and may apply in general, to a single audience, or to a single campaign. The quantitative goals may be categorized based on performance outcomes. This is why the advertisers or sellers 20 may target different audiences, with different goals being sought.

The intelligent agents 4 and 6 act on behalf of the advertiser or seller 20, or on behalf of the consumer 18, depending on their goals, and automatically adapt their offer to the outcome performances and the goals sought by the advertisers or sellers. The respective goals and interests of the consumer, the advertiser or seller, and the platform operator are articulated, entered into the system, and taken into consideration by the agents working in concert.

The system makes it possible to carry out various measures of performance or impact, including those received from outside systems.

The invention entails the cooperation of intelligent agents, and thereby makes it possible to dynamically and optimally organize the selection of an advertisement when a large number of parameters (both from advertisers and sellers and from service providers) must be taken into consideration. To that end, the invention offers several options:
different audiences may be targeted simultaneously, by associating separate and specific marketing goals with one another.
the goals may be qualitative (for example, generating familiarity by means of sufficient exposure) or quantitative (such as being categorized by impact results);
the invention enables the automatic adaptation of the advertising offer, based on performance outcomes, based on advertisements, based on campaigns and based on the goals sought by the advertiser or seller;
the agents working in concert take into consideration the consumers, the advertisers and sellers, and the policy and interests of the advertising platform.

Naturally, numerous changes may be made to the invention without departing from the scope thereof.

The characteristics regarding the commercial agent 4 may be used in a manner independent of those regarding the consumer agent 6, particularly in the absence of the latter, and vice versa.

1. A method for selecting an advertising message to send to a user's (18) device (40), characterized in that it includes the following steps:
a slot wherein an advertising message may be issued on the device (40) which has become available.
a management device (6) of the user sends advertising-related user data to a decision apparatus (8);
the decision apparatus (8) converts said data in order to produce the user's (18) criteria;
the decision apparatus (8) sends the user's (18) criteria to a plurality of commercial devices;
each of the commercial devices (4) selects a piece of content from among multiple pieces of advertising content based on commercial device criteria (4) and criteria which is specific to the user and distinct from the commercial device's criteria, then sends the selected content to a decision apparatus (8);
the decision apparatus (8) selects a piece of content to distribute from among the content received from the commercial devices (4);
a sending manager distributes the selected content to the user's apparatus (40).

2. A method according to claim 1, wherein each commercial device (4) corresponds specifically to a respective predetermined company or advertiser (20).

3. A method according to claim 1, wherein at least one of the following components of the commercial device (4) sends at least one of the commercial device's criteria to a decision-making component (28) of the commercial device:
a target audience management component (22);
a commercial goal management component (21);
an advertising impact checking component (24); and
a budget management component (26).

4. A method according to claim 1, wherein the commercial device's criteria comprise at least one of the following criteria:
a commercial communication goal criterion;
recorded advertising performance indicator criterion;
a budget criterion;
target audience criterion;
a predetermined interests criterion, and
preferably all of these criteria.

5. A method according to claim 1, wherein the decision apparatus (8) selects the content, taking into account criteria distinct from the user criteria and distinct from the criteria of the (or each) commercial device (4).

6. A program characterized in that it comprises instructions capable of controlling the execution of the steps of a method according to claim 1 when it is run on a computer.

7. A data recording medium, characterized in that it comprises a program according to claim 6.

8. A method for making a program according to claim 6 available over a telecommunication network, so that it may be downloaded.
